(19) United States
(12) Patent Application Publication
(10) Pub. No.: US 2002/0015209 A1
(43) Pub. Date: Feb. 7, 2002

(54) Data signal transfer method with simplified switching

(76) Inventor: Yukihiko Suzuki, Tokyo (JP)

Correspondence Address: Venable, P.O. Box 34385, Washington, DC, 20043-9998, US

(21) Appl. No.: 09/888,650

(22) Filed: Jun. 26, 2001

(30) Foreign Application Priority Data
Aug. 3, 2000 (JP) 235153/00

(51) Int. Cl. H04J 14/00; H04B 10/12

(52) U.S. Cl. 359/173; 359/117

(57) ABSTRACT

In a data signal transfer system in which a transmitting node transmits data to a plurality of receiving nodes on an optical transmission line, all of the receiving nodes are initialized to a state for receiving the transmitted data. Thereafter, the nodes are switched one at a time between this state and another state, in which they pass the transmitted data through to the next node. As seen from the transmitting node, the switched node is always either the closest node currently in the receiving state, or a closer node currently in the pass-through state. Transmitted data are received by the closest node in the receiving state. This arrangement enables destination switching to be carried out with a minimum of control signaling, and data can be transmitted to all receiving nodes on the same wavelength.

### BACKGROUND OF THE INVENTION

The present invention relates to a signal transfer method useful in an optical data transmission network, such as a network employing wavelength division multiplexing and optical add-drop multiplexers.

Various methods of transferring data in wavelength division multiplex (WDM) networks have been considered.

FIG. 8 is a highly simplified block diagram illustrating one such method. The data transfer system 50 in this drawing comprises a first node 51, a second node 52, and a third node 53. A first optical path 54, using a certain wavelength λ₁, is established between the first node 51 and second node 52. A second optical path 55, using another wavelength λ₂, is established between the first node 51 and third node 53. The first optical path 54 is used to transfer data from the first node 51 to the second node 52; the second optical path 55 is used to transfer data from the first node 51 to the third node 53. The first and second optical paths 54, 55 are, for example, separate wavelength channels in a single optical signal, wavelengths λ₁ and λ₂ being added at the first node 51, wavelength λ₁ being dropped at the second node 52, and wavelength λ₂ being dropped at the third node 53.

In a different method, the first and second optical paths 54, 55 in FIG. 8 use the same wavelength λ. In this method, after the first optical path 54 has been set up between the first node 51 and the second node 52, using wavelength λ, it must be removed before the second optical path 55 can be set up between the first node 51 and the third node 53, using the same wavelength λ. FIG. 9 shows the signaling sequence involved in this removal and set-up operation, the direction marked t corresponding to time.

At the top of FIG. 9, the second optical path 55 has been set up, and data D(51-53) are being transferred from the first node 51 to the third node 53. After this transfer, the transfer destination is switched from the third node 53 to the second node 52 by the following procedure.

The first node 51 sets its internal configuration so as to release the second optical path 55, and sends a remove request signal REM(51-53) to the third node 53.

The third node 53 receives this signal REM(51-53), sets its internal configuration so as to remove the second optical path 55, and returns an acknowledge signal ACK(53-51) to the first node 51 when the setting is completed.

Upon receiving the acknowledge signal ACK(53-51) from the third node 53, the first node 51 sends the second node 52 a path set-up signal SET(51-52) requesting set-up of the first optical path 54.

The second node 52 receives this signal SET(51-52), sets its internal configuration so as to set up the first optical path 54, and returns an acknowledge signal ACK(52-51) to the first node 51 when the setting is completed.

Upon receiving the acknowledge signal ACK(52-51) from the second node 52, the first node 51 sets its internal configuration so as set up the first optical path 54 and transfers data D(51-52) to the second node 52.

Following this transfer, if the first node 51 has more data D(51-53) to transfer to the third node 53, it executes a similar procedure to switch the transfer destination again, sending a remove request signal REM(51-52) and receiving an acknowledge signal ACK(52-51), thus removing the first optical path 54, and sending a path set-up signal SET(51-53) and receiving an acknowledge signal ACK(53-51), thus reestablishing the second optical path 55.

When a different wavelength is used for each path between each different pair of nodes, as in the first method described above, filters become necessary for each of the wavelengths. A large network requires a large number of these filters and has a complex hardware configuration.

When the second method described above is used to transfer data to different nodes on the same wavelength, in order to switch destinations, it is necessary to send path set-up and remove commands and execute and acknowledge them by the procedure described in FIG. 9, which takes time. This path-switching procedure limits the data transfer efficiency, because data cannot be transferred while the path-switching procedure is being carried out.

### SUMMARY OF THE INVENTION

An object of the present invention is to provide a more efficient way of transferring data optically to a plurality of receiving nodes, using the same wavelength of light for all of the receiving nodes.

The invented method of transferring data pertains to a system in which at least a first node, a second node, and a third node are coupled in series on an optical transmission line. In the invented method, the second and third nodes are initialized to a first state for receiving data from the first node. Then the second node is switched between the first and a second state. The second state is a pass-through state, in which the second node passes data from the first node to the third node. The first node transmits data toward the second and third nodes. When the second node is in the first state, the second node receives the data. When the second node is in the second state, the third node receives the data.

The system may include any number of nodes coupled in series on the optical transmission line. One of the nodes is a transmitting node, transmitting data toward a plurality of receiving nodes. All of the receiving nodes are initialized to the receiving state. Thereafter, the nodes can be switched, one at a time, from the receiving state to the pass-through state, or from the pass-through state to the receiving state. As seen from the transmitting node, the node that gets switched is either the closest node currently in the receiving state, or a closer node currently in the pass-through state. Transmitted data are received by the closest node in the receiving state.

### BRIEF DESCRIPTION OF THE DRAWINGS

In the attached drawings:

FIG. 1 is a partial block diagram of a transfer system illustrating a first embodiment of the invention;

FIG. 2 is a flowchart summarizing a procedure for initializing the nodes in FIG. 1;

FIG. 3 is a signaling sequence diagram illustrating the operation of the first embodiment;

FIG. 4 is a block diagram illustrating the internal structure of a node in a second embodiment of the invention;

FIG. 5 is a block diagram illustrating the overall system structure of the second embodiment;

FIG. 6 is a partial block diagram illustrating an initial operating state of the second embodiment;

FIG. 7 is a signaling sequence diagram illustrating the operation of the second embodiment;

FIG. 8 is a simplified block diagram of a conventional optical data transfer system; and

FIG. 9 is a signaling sequence diagram illustrating a conventional method of switching transfer destinations.

### DETAILED DESCRIPTION OF THE INVENTION

Embodiments of the invention will be described with reference to the attached drawings, in which like parts are indicated by like reference characters.

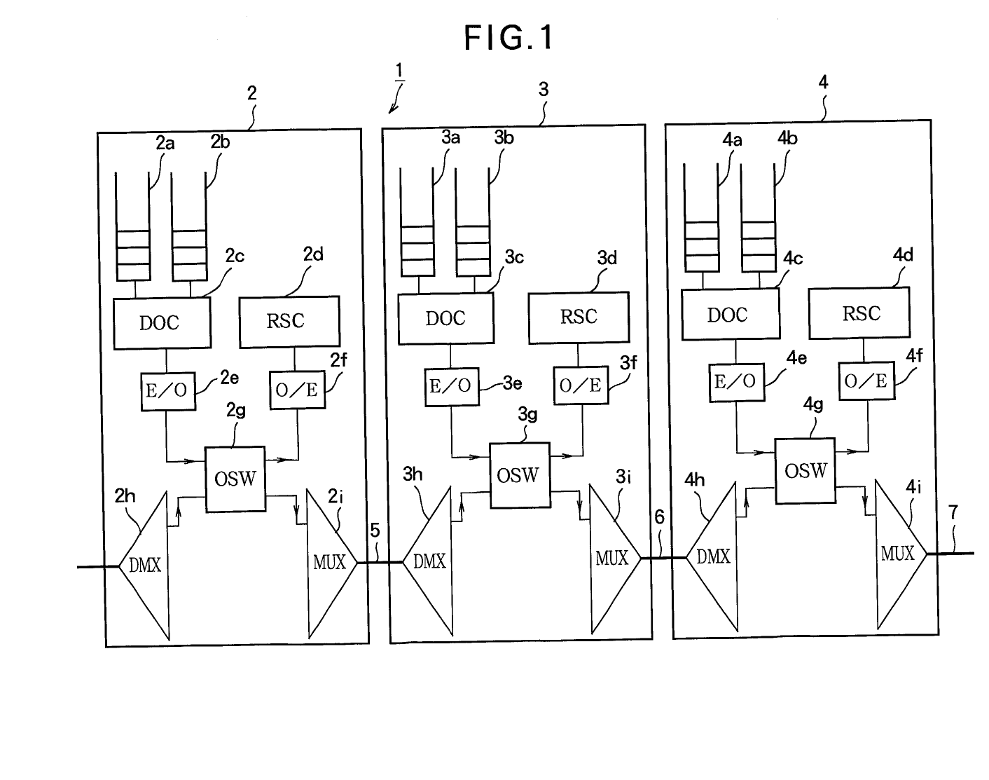

FIG. 1 is a partial block diagram of a first transfer system 1 embodying the present invention. The system 1 comprises three nodes 2, 3, 4 linked by optical transmission lines 5, 6.

Node 2 has a first buffer 2a and a second buffer 2b that store transmit data to be sent to the other nodes 3, 4. These buffers 2a, 2b supply transmit data to the input ports of a data output controller (DOC) 2c. The output port of the data output controller 2c is coupled to the input port of an electro-optic (E/O) converter 2e. The output port of the electro-optic converter 2e is coupled to an input port of an optical switch (OSW) 2g. The optical switch 2g has two input ports and two output ports. One output port is coupled to the input port of an opto-electric (O/E) converter 2f. The output port of the opto-electric converter 2f is coupled to a receive signal controller (RSC) 2d. The other input port of the optical switch 2g is coupled to a demultiplexer (DMX) 2h. The other output port of the optical switch 2g is coupled through a multiplexer (MUX) 2i to optical transmission line 5.

The optical switch 2g, demultiplexer 2h, and multiplexer 2i constitute an optical add-drop multiplexer (OADM). The OADM may have a plurality of optical switches coupled between the multiplexer 2i and demultiplexer 2h, each optical switch switching a different wavelength of light, but for simplicity only one optical switch 2g is shown in the drawing.

Node 3 has a similar structure with buffers 3a, 3b, a data output controller 3c, a receive signal controller 3d, an electro-optic converter 3e, an opto-electric converter 3f, an optical switch 3g, a demultiplexer 3h, and a multiplexer 3i. The demultiplexer 3h couples optical transmission line 5 to the optical switch 3g; the multiplexer 3i couples the optical switch 3g to optical transmission line 6.

Node 4 has a similar structure with buffers 4a, 4b, a data output controller 4c, a receive signal controller 4d, an electro-optic converter 4e, an opto-electric converter 4f, an optical switch 4g, a demultiplexer 4h, and a multiplexer 4i. The demultiplexer 4h couples optical transmission line 6 to the optical switch 4g; the multiplexer 4i couples the optical switch 4g to another optical transmission line 7.

The optical switches 2g, 3g, 4g can connect their two input ports to their two output ports in either a cross state or a parallel state. If optical switch 3g is taken as an example, in the parallel state, the optical signal from demultiplexer 3h is coupled to multiplexer 3i. In the cross state, the optical signal from electro-optic converter 3e is coupled to multiplexer 3i, and the optical signal from demultiplexer 3h is coupled to opto-electric converter 3f. The cross state is both a transmitting state and a receiving state; the parallel state is a pass-through state.

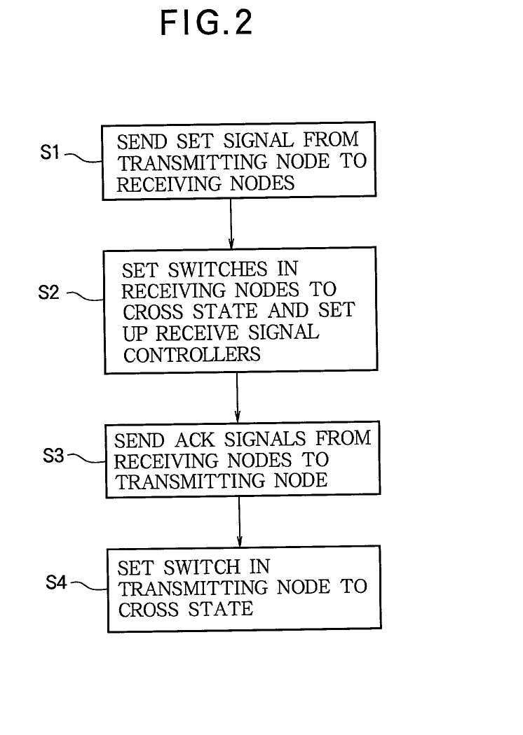

Next, the transfer of data from node 2 to nodes 3 and 4, using light of the same wavelength for both destinations, will be described. FIG. 2 outlines the initial settings of each node.

First, node 2 (the transmitting node) sends node 3 and node 4 (the receiving nodes) a set signal, requesting that they set up to receive data (step S1). Nodes 3 and 4 respond by setting their optical switches 3g, 4g to the cross state, and setting their receive signal controllers 3d, 4d to store the signals received from the opto-electric converters 3f, 4f (step S2). When these settings are completed and node 3 and node 4 are ready to receive, they return respective acknowledge (ACK) signals to node 1 (step S3).

The set and acknowledge signals may be transmitted on a separate signaling channel (not shown), on a separate wavelength for example.

Before transferring data, node 2 places data to be transferred to node 3 in the first buffer 2a and data to be transferred to node 4 in the second buffer 2b, and sets its optical switch 2g to the cross state (step S4).

After this initialization, the data output controller 2c in node 2 operates to transfer data from the first buffer 2a to the electro-optic converter 2e, thus through the optical switch 2g and multiplexer 2i to optical transmission line 5. In node 3, the data signal travels through the demultiplexer 3h, optical switch 3g, and opto-electric converter 3f to the receive signal controller 3d, which has been set up to receive the data by the preceding SET signal.

Next, to transfer data from the second buffer 2b to node 4, the data output controller 2c in node 2 temporarily halts the transfer of data from the first buffer 2a to node 3, and node 2 sends node 3 a switching request signal. Upon receiving this signal, node 3 sets its optical switch 3g to the parallel state and returns an acknowledge signal to node 2.

When node 2 receives the acknowledge signal from node 3, the data output controller 2c begins output of data from the second buffer 2b. The data signal travels through the optical switch 2g and multiplexer 2i onto optical transmission line 5, then through the demultiplexer 3h, optical switch 3g, and multiplexer 3i in node 3 onto optical transmission line 6. In node 4, the data signal travels through the demultiplexer 4h, optical switch 4g, and optoelectric converter 4f to the receive signal controller 4d, which has been set up to receive the data by the earlier set signal.

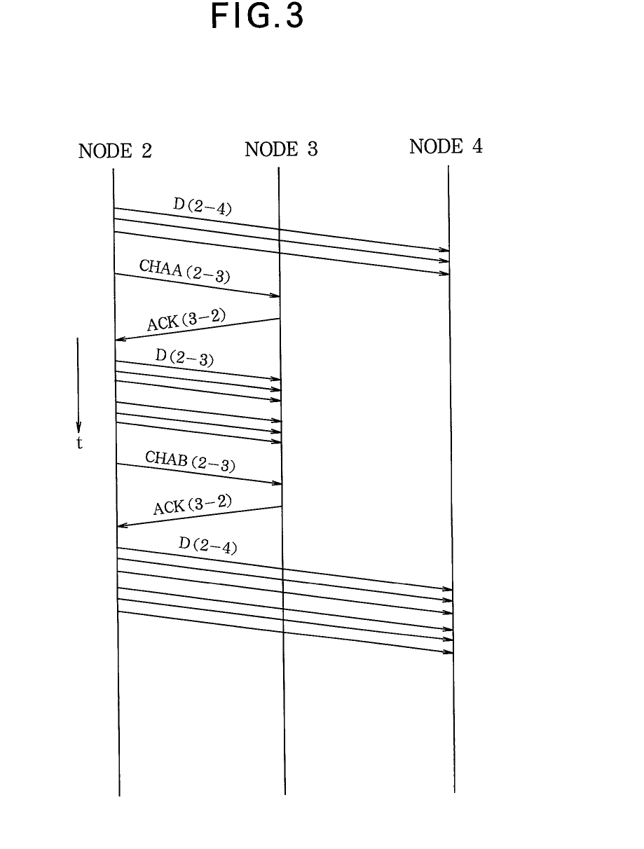

FIG. 3 illustrates further data transfers, the arrow marked t indicating time.

At the top of FIG. 3, data D(2-4) are being transferred from node 2 to node 4.

To switch back to transferring data to node 3, node 2 sends node 3 a switching request signal CHAA(2-3).

Upon receiving this signal CHAA(2-3), node 3 sets its optical switch 3g to the cross state, and returns an acknowledge signal ACK(3-2) to node 2.

When node 2 receives the acknowledge signal ACK(3-2) from node 3, the data output controller 2c in node 2 begins output of data D(2-3) from the first buffer 2a. These data travel through optical transmission line 5 and are received in the receive signal controller 3d in node 3 as explained above.

To switch to transferring data to node 4 again, node 2 sends node 3 a switching request signal CHAB(2-3).

Upon receiving this signal CHAB(2-3), node 3 sets its optical switch 3g to the parallel state, and returns an acknowledge signal ACK(3-2) to node 2.

When node 2 receives the acknowledge signal ACK(3-2) from node 3, the data output controller 2c in node 2 begins output of data D(2-4) from the second buffer 2b. These data travel through optical transmission lines 5, 6 and are received in the receive signal controller 4d in node 4 as explained above.

During the transfer of data to the two receiving nodes 3, 4, at each switch of destination between node 3 and node 4, it is only necessary to send one switching request signal and one acknowledge signal and change the state of the optical switch 3g in node 3. A comparison with FIG. 9 shows that less signaling is required than in the conventional art. Accordingly, the switching time is reduced and data can be transferred more efficiently.

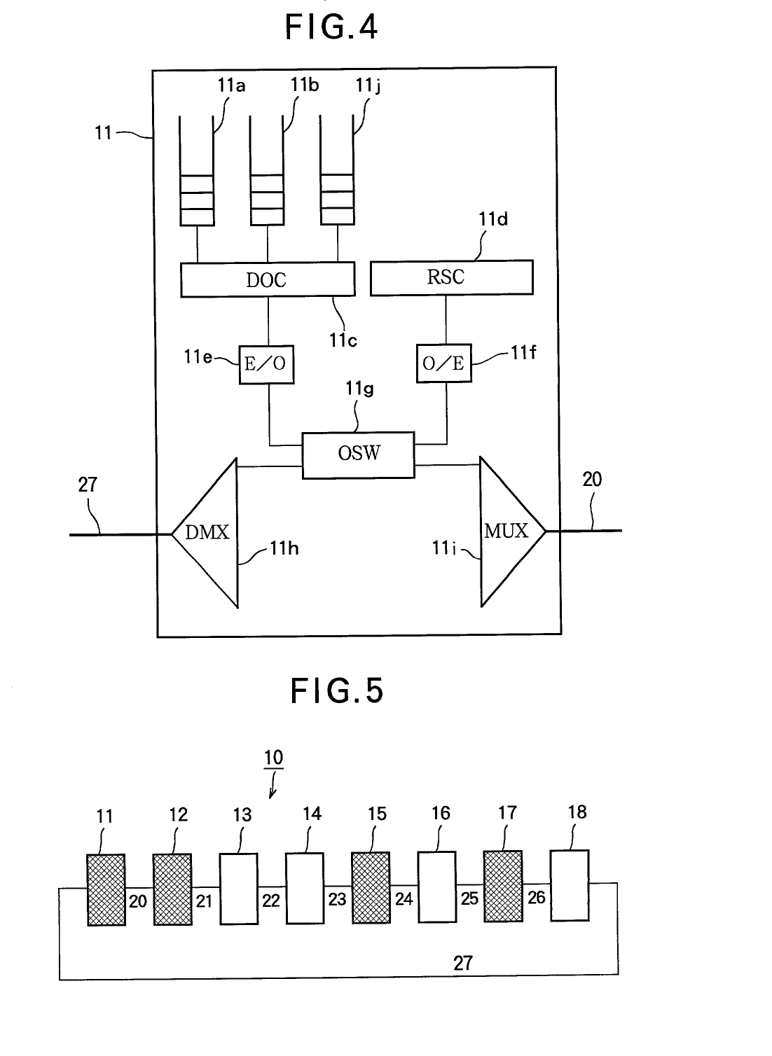

FIG. 4 shows the internal structure of a node in a transfer system illustrating a second embodiment of the invention. Differing from the nodes 2, 3, 4 of the first embodiment, this node 11 has three buffers 11a, 11b, 11j that supply transmit data to a data output controller 11c. In other respects, node 11 is similar to the above-described nodes 2, 3, 4, comprising a receive signal controller lid, an electro-optic converter lie, an opto-electric converter 11f, an optical switch 11g, a demultiplexer 11h, and a multiplexer 11i. The demultiplexer 11h is coupled to an optical transmission line 27 from which node 11 receives data signals. The multiplexer 11i is coupled to an optical transmission line 20 to which node 11 supplies data signals.

FIG. 5 shows the overall structure of the transfer system 10 in the second embodiment. The system 10 comprises a plurality of nodes 11 to 18 coupled in a ring by optical transmission lines 20 to 27. All of the nodes 11 to 18 have the structure shown in FIG. 4.

The operation of the second embodiment will be described below for the case in which node 11 uses the same wavelength of light to transmit data to node 12, node 15, and node 17. These four nodes are indicated by hatching in FIG. 5. In node 11, data to be transferred to node 12 are placed in the first buffer 11a, data to be transferred to node 15 are placed in the second buffer 11b, and data to be transferred to node 17 are placed in the third buffer 11j. The operation starts from a state in which the optical switches in all nodes are set to the parallel state.

The nodes are initialized substantially as described in the first embodiment. The transmitting node 11 sends a set signal to the receiving nodes 12, 15, 17. The receiving nodes 12, 15, 17 respond to the set signal by setting their optical switches to the cross state and preparing their receive signal controllers to receive data, then return acknowledge signals to node 11. The transmitting node 11 then sets its own optical switch 11g to the cross state.

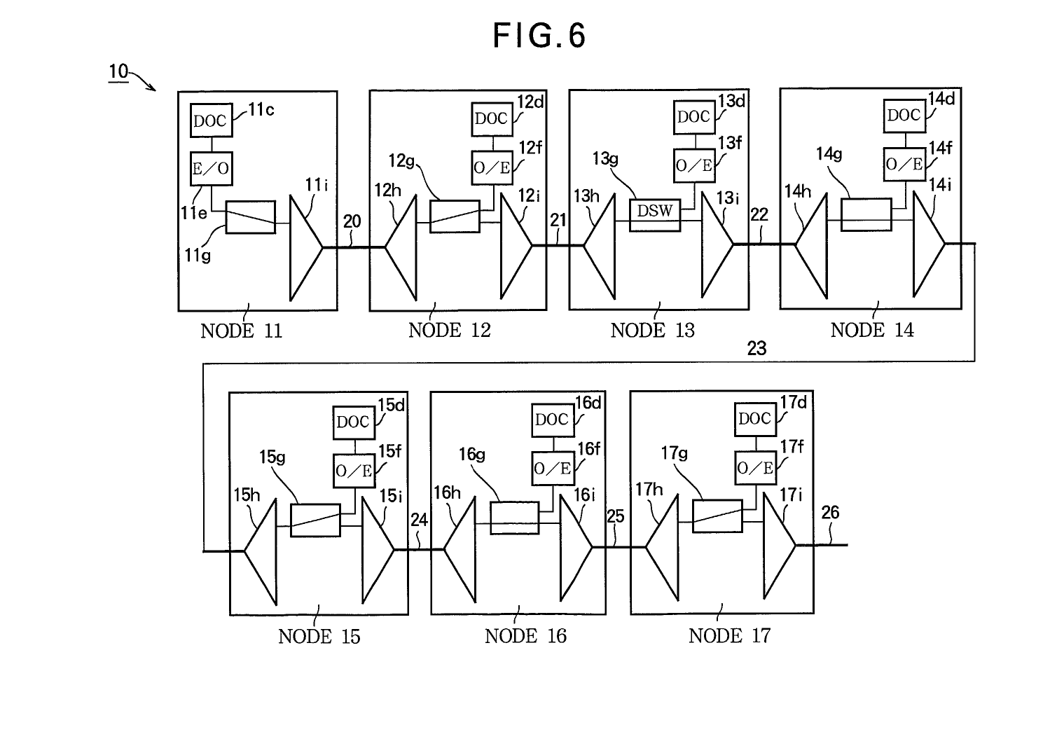

FIG. 6 shows the states of nodes 11 to 17 at the end of the initialization procedure. In node 11, the optical switch 11g is set to the cross state to pass transmit data from the data output controller 11a through the multiplexer 11i onto optical transmission line 20. In nodes 12, 15, 17, the optical switches 12g, 15g, 17g are set to the cross state to pass incoming data to the receive signal controllers 12d, 15d, 17d. In nodes 13, 14, 16, the optical switches 13g, 14g, 16g are set to the parallel state to pass data from the incoming line through to the outgoing line.

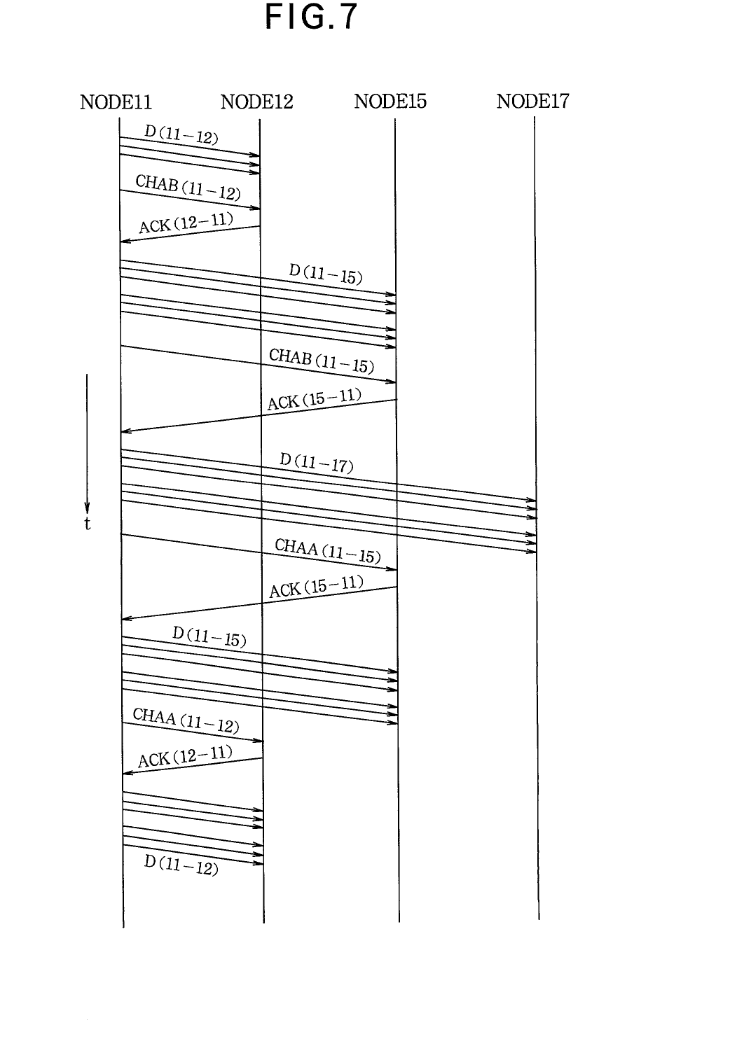

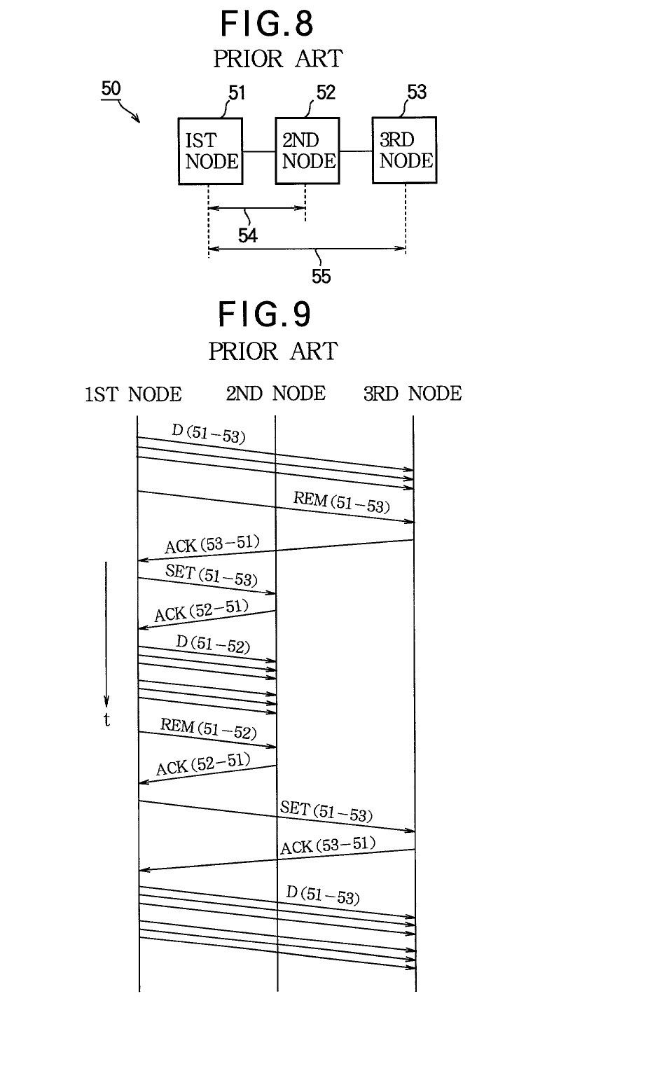

Referring to FIG. 7, in this initialized state, the data output controller 11c in node 11 begins sending data D(11-12) from the first buffer 11a to the optical switch 11g. Since the optical switches 11g, 12g in nodes 11 and 12 are set to the cross state, the data D(11-12) are transferred on optical transmission line 20 from node 11 to node 12, received by the opto-electric converter 12f in node 12, and passed to the receive signal controller 12d.

Next, to send data to node 15, the data output controller 11c in node 11 temporarily halts the output of data to the optical switch 11g, and node 11 sends a switching request signal CHAB(11-12) to node 12. Node 12 receives this signal, sets its optical switch 12g to the parallel state, and returns an acknowledge signal ACK(12-11) to node 11.

When node 11 receives this acknowledge signal ACK(12-11), the data output controller 11c begins transferring data D(11-15) from the second buffer 11b onto optical transmission line 20. Since the optical switches 12g, 13g, 14g in nodes 12, 13, 14 are set to the parallel state, the data pass through these nodes to node 15. Since the optical switch 15g in node 15 is set to the cross state, the data are received there by the opto-electric converter 15f and passed to the receive signal controller 15d.

Next, to send data to node 17, the data output controller 11c in node 11 temporarily halts the output of data to the optical switch 11g, and node 11 sends a switching request signal CHAB(11-15) to node 15. Node 15 receives this signal, sets its optical switch 15g to the parallel state, and returns an acknowledge signal ACK(15-11) to node 11.

When node 11 receives this acknowledge signal ACK(15-11), the data output controller 11c begins transferring data D(11-17) from the third buffer 11j onto optical transmission line 20. Since the optical switches 12g, 13g, 14g, 15g, 16g in nodes 12, 13, 14, 15, 16 are set to the parallel state, the data pass through these nodes to node 17. Since the optical switch 17g in node 17 is set to the cross state, the data are received there by the opto-electric converter 17f and passed to the receive signal controller 17d.

Next, to send data to node 15 again, the data output controller 11c in node 11 temporarily halts the output of data to the optical switch 11g, and node 11 sends a switching request signal CHAA(11-15) to node 15. Node 15 receives this signal, sets its optical switch 15g to the cross state, and returns an acknowledge signal ACK(15-11) to node 11.

When node 11 receives this acknowledge signal ACK(15-11), the data output controller 11c begins transferring data D(11-15) from the second buffer 11b onto optical transmission line 20. Since the optical switches 12g, 13g, 14g in nodes 12, 13, 14 are set to the parallel state, the data pass through these nodes to node 15. Since the optical switch 15g in node 15 is set to the cross state, the data are received there by the opto-electric converter 15f and passed to the receive signal controller 15d.

Next, to send data to node 12 again, the data output controller 11c in node 11 temporarily halts the output of data to the optical switch 11g, and node 11 sends a switching request signal CHAA(11-12) to node 12. Node 12 receives this signal, sets its optical switch 12g to the cross state, and returns an acknowledge signal ACK(12-11) to node 11.

When node 11 receives this acknowledge signal ACK(12-11), the data output controller 11c begins transferring data D(11-12) from the first buffer 11a onto optical transmission line 20. Since the optical switch 12g in node 12 is set to the cross state, the data are received there by the optoelectric converter 12f and passed to the receive signal controller 12d. At this point, the system 10 is once again in the state established by the initial settings.

As illustrated in FIG. 7, the transmitting node can transfer data to a series of nodes in order from a closest node to a farthest node, or from a farthest node to a closest node, with a minimum of signaling. To switch between two destination nodes, the transmitting node only has to send one switching request signal to the closer of those two nodes, and receive one acknowledge from that node.

As compared with conventional optical data transfer methods employing the same wavelength for transfers from a transmitting node to multiple receiving nodes, the invented method shortens the destination switching procedure so that only a single request-acknowledge control signal exchange is required. The time saved in this way can be used to transfer more data, so the data transfer efficiency is improved.

Furthermore, when the data destination is switched from one node to another node, the control signal exchange is always conducted with the closer one of the two destination nodes. Since the control signals travel at finite speeds, minimizing the distance to be traveled also minimizes the signal travel time, further contributing to the shortening of the control signaling time and improved data transfer efficiency.

The invention is not limited to the use of a single wavelength. In the first embodiment, for example, node 3 may be equipped with a wavelength conversion function, and one wavelength may be used on optical transmission line 5 while another wavelength is used on optical transmission line 6.

In the second embodiment, the number of destination nodes is not limited to three. The same general procedure can be used to send data to any number of nodes.

In the second embodiment, the destination node was switched in an ascending sequence from the nearest node to the farthest node, then in a mirror descending sequence from the farthest node to the nearest node (node 12, node 15, node 17, node 15, node 12), but the destination node can also be switched in other sequences (node 12, node 15, node 17, node 12, node 17, node 15, node 12, for example). The node that is switched is always either the closest node currently in the cross state, or a closer node currently in the parallel state, as seen from the transmitting node, looking in the transmitting direction. As long as this switching rule is followed, only one request-acknowledge signaling exchange is necessary at each switchover.

Those skilled in the art will recognize that further variations are possible within the scope claimed below.

What is claimed is:

1. A method of transferring data in a system having a first node, a second node, a third node, a first optical transmission line connecting the first node to the second node, and a second optical transmission line connecting the second node to the third node, comprising the steps of:
(a) initializing the second node and the third node to a first state for receiving data from the first node;
(b) switching the second node between the first state and a second state, the second state being a state for passing data from the first optical transmission line to the second optical transmission line;
(c) transmitting data from the first node on the first optical transmission line;
(d) receiving the transmitted data at the second node when the second node is in the first state; and
(e) receiving the transmitted data at the third node when the second node is in the second state.

2. The method of claim 1, wherein said step (c) employs a predetermined wavelength of light regardless of whether the transmitted data are received by the second node in step (d) or the third node in step (e).

3. The method of claim 1, wherein said step (b) comprises operating an optical switch in the second node.

4. The method of claim 1, wherein said step (b) further comprises the steps of:
sending a switching request signal from the first node to the second node; and
returning an acknowledge signal from the second node to the first node.

5. A method of transferring data from a transmitting node to a plurality of receiving nodes on an optical transmission line extending from the transmitting node to the receiving nodes in series, each one of the receiving modes being operable in a first state for receiving data transmitted by the transmitting node on the optical transmission line, and a second state for passing the transmitted data to a next one of the receiving nodes on the optical transmission line, comprising the steps of:
(a) initializing all of the receiving nodes to the first state;
(b) transmitting data from the transmitting node on the optical transmission line toward the receiving nodes;
(c) receiving the transmitted data at a destination node, the destination node being whichever one of the receiving nodes currently set to the first state is closest to the transmitting node on the optical transmission line;
(d) switching the destination node from the first state to the second state, thereby enabling a more distant one of the receiving modes to become the destination node; and
(e) switching one of the receiving nodes, disposed closer than the destination node to the transmitting node on the optical transmission line, from the second state to the first state, thereby enabling the switched one of the receiving nodes to become the destination node.

6. The method of claim 5, wherein said step (b) employs a predetermined wavelength of light regardless of which of the receiving nodes receives the transmitted data.

7. The method of claim 5, wherein the receiving nodes have respective optical switches, and said step (d) and said step (e) are carried out by operating the optical switches.

8. The method of claim 5, wherein the one of the receiving nodes switched in said step (e) is, among those of the receiving nodes that are closer than the destination node to the transmitting node on the optical transmission, the one farthest from the transmitting node.

9. The method of claim 5, wherein said step (d) further comprises the steps of:
sending a switching request signal from the transmitting node to the destination node; and
returning an acknowledge signal in reply to the switching request signal.

10. The method of claim 5, wherein said step (e) further comprises the steps of:
sending a switching request signal from the transmitting node to said one of the receiving nodes disposed closer than the destination node to the transmitting node on the optical transmission line; and
returning an acknowledge signal in reply to the switching request signal.
